(19) United States
(12) Patent Application Publication
(10) Pub. No.: US 2011/0139335 A1
(43) Pub. Date: Jun. 16, 2011

(54) Method of Fabricating LCD Panel

(76) Inventor: CheMing HSU, Tainan County (TW)

(21) Appl. No.: 13/035,840

(22) Filed: Feb. 25, 2011

Related U.S. Application Data
(62) Division of application No. 11/149,136, filed on Jun. 10, 2005, now abandoned.

(30) Foreign Application Priority Data
Jun. 30, 2004 (TW) 093119712

(51) Int. Cl. B32B 38/04; B32B 38/00; B32B 37/14; B32B 37/02

(52) U.S. Cl. 156/64; 156/273.9

(57) ABSTRACT

A method of fabricating a liquid crystal display, using one-drop-filling (ODF) method to inject liquid crystal material between two parallel substrates, while a signal input terminal on the substrate is exposed. A voltage and ultra-violet radiation are applied to the signal input terminal synchronously, such that the monomers can be polymerized to stabilize the liquid crystal molecules and to photo-cure a sealant. Thereby, the damage of liquid crystal molecules caused ultra-violet radiation is minimized, the fabrication process is simplified, and the cost of process equipment is reduced.

### CROSS-REFERENCE

This application is a divisional application of U.S. patent application Ser. No. 11/149,136, filed on Jun. 10, 2005.

### BACKGROUND OF THE INVENTION

1. Field of Invention

The present invention relates in general to a method of fabricating a liquid crystal display panel with improved polymer-stabilized liquid crystal (PSLC).

2. Related Art

Polymer-stabilized liquid crystal (PSLC) is an improve liquid crystal mode used for enhancing response speed. Referring to FIG. 1, a process for assembling a conventional liquid crystal cell is illustrated. In step 100, two substrates with a thin-film transistor array (TFT array) and a color filter are prepared. In step 101, alignment films are coated on two substrates. In step 103, alignment is performed on the alignment films. In step 105, the sealant coating is performed, that is, the sealant is applied to the substrate on which the thin-film transistor array or the color filter is formed.

Steps 111 to 117 are performed within a one-drop-filling system 110. In step 111, the liquid crystal material is applied on the substrate with the color filter by the one-drop-filling method. The liquid crystal material includes both liquid crystal molecules and small amount of polymerizing monomers. The substrates are then laminated with each other in step 113. In step 115, ultra-violet radiation with a first energy level is applied with a liquid crystal mask to perform curing of the sealant. When the sealant is photo-cured, a thermal processing step is performed to further cure the sealant. In step 120, the substrate is cut, followed by polymer-stabilized liquid crystal process. In step 130, with the application of an electric field, ultra-violet radiation with a second energy level is applied to the liquid crystal material, such that the monomers are polymerized to stabilize the liquid crystal molecules. The second energy level is lower than the first energy level. When the polymer-stabilization on the liquid crystal is performed, lit-up inspection is performed to inspect whether there is any defect on the liquid display panel. The detailed light-on inspection will be further described later.

FIG. 2 shows a schematic drawing of the polymer and the liquid crystal molecules. While applying voltage 205 to the liquid crystal molecules 203 on the substrate 201, the liquid crystal molecules 203 spin to a stable state. The stable state is the arrangement status of the liquid crystal molecules 205 while being driven by the voltage. While applying the voltage 205, ultra-violet radiation 207 is applied simultaneously. Thereby, the polymerizing monomer in the liquid crystal material will be polymerized into polymer 209, which that the liquid crystal molecules 203 are stabilized at a predetermined azimuth which is advantageous to the alignment of the liquid crystal molecules 203. When the liquid crystal display is fabricated, the polymer-stabilized liquid crystal molecules 203 will be twisted to the predetermine azimuth faster when the polymer 206 and the liquid crystal molecules 203 are subjected to an operation voltage. The response time is thus shortened.

To comply with the above fabrication process, a driving circuit is allocated in a liquid crystal display panel. The driving circuit for a conventional liquid crystal display panel is shown in FIG. 3. Typically, the liquid crystal display panel 300 includes at least two parallel substrates 301 and 303 and a sealant disposed in between. The substrate 303 includes opaque area 305 and transparent area 307 defined by color filter. The substrate 301 includes a plurality of parallel data lines 315 and a plurality of parallel gate lines 317. The gate lines 317 are perpendicular to the data lines 315. A signal input circuit is formed on the substrate 301 to couple with the data line 315 or the gate line 317. The signal input circuit extends to the edge of the substrate 301. When the substrates 301 is laminated with the substrate 303, a part of the signal input circuit, signal input terminals A and B are exposed. The typical signal input terminals A and B serve as testing electrodes. The intersection between the signal input circuit and each data line 315 or each gate line 317 includes a transfer unit 319, which can be a thin-film transistor.

During the polymer-stabilization process of the liquid crystal, a probe can be used to input voltage to the signal input terminal A or B, so as to stabilize the liquid crystal molecules to the predetermined azimuth. In the light-on test for the conventional liquid crystal display panel 300, the signals obtained from the input signal terminal A or B is input to the data line 315 or gate line 317 via the transfer unit 319, such that the brightness, contrast ratio or existence of defect such as bad spot or line can be inspected.

In brief, although the above one-drop-filling liquid crystal fabrication process and the polymer-stabilized liquid crystal fabrication process simplify the process and provide a fast response of the liquid crystal display panel, additional cost is required to purchase the specific machine to perform such process. Further, as two ultra-violet radiations are applied to the liquid crystal molecules, the exposure damage of the liquid crystal molecules is inevitable.

It is therefore a substantially need to provide a fabrication method for a liquid crystal display panel with reduced machine cost, reduced ultra-violet radiation, and simplified process.

### SUMMARY OF THE INVENTION

A method of fabricating a liquid crystal display panel is provided in the present invention. By using a one-drop-filling method, a liquid crystal material is injected between two parallel substrates with a signal input exposed. A voltage is applied to the signal input terminal and a ultra-violet beam is radiating, such that the monomers in the liquid crystal material are polymerized to form stabilized liquid crystal molecules and photo-cure a sealant between the substrates. As the ultra-violet radiation is applied only once, the damage caused thereby is suppressed. In addition, the simplified process provides better viewing angle of the liquid crystal display panel.

Accordingly, the method of fabricating a liquid crystal display panel of the present invention includes providing two substrates and a sealant formed on at least one of the substrates, applying a liquid crystal material on at last one of the substrate, wherein the liquid crystal material includes at least a plurality of liquid crystal molecules and a monomer, laminating the substrates in parallel and keeping at least one signal input terminal exposed, and applying a voltage to the signal input terminal and radiating the liquid crystal material by an ultraviolet beam synchronously to polymerize the monomer, so as to photo-cure the sealant.

The applied voltage is about 1V to about 20V. Furthermore, a step of thermal process to thermally cure the sealant is provided after applying the voltage to the signal input terminal and radiating the liquid crystal material by the ultraviolet beam synchronously. A light-on inspection by supplying a signal via the exposed signal input terminal is then performed thereafter.

By the above fabrication process, the polymer-stabilization of the liquid crystal and photo-cure process are synchronously performed. By a subsequent light-on inspection process can be performed on the signal input terminal formed by the same fabrication process to scan signal. Thereby, the ultra-violet exposure is minimized, and the damage of liquid crystal molecules caused thereby is suppressed. A better liquid crystal display panel is thus provided with simpler process and reduced cost.

### BRIEF DESCRIPTION OF THE DRAWINGS

The present invention will become more fully understood from the detailed description given hereinbelow illustration only, and thus are not limitative of the present invention, and wherein:

FIG. 1 shows the fabrication process of a conventional liquid crystal display panel;

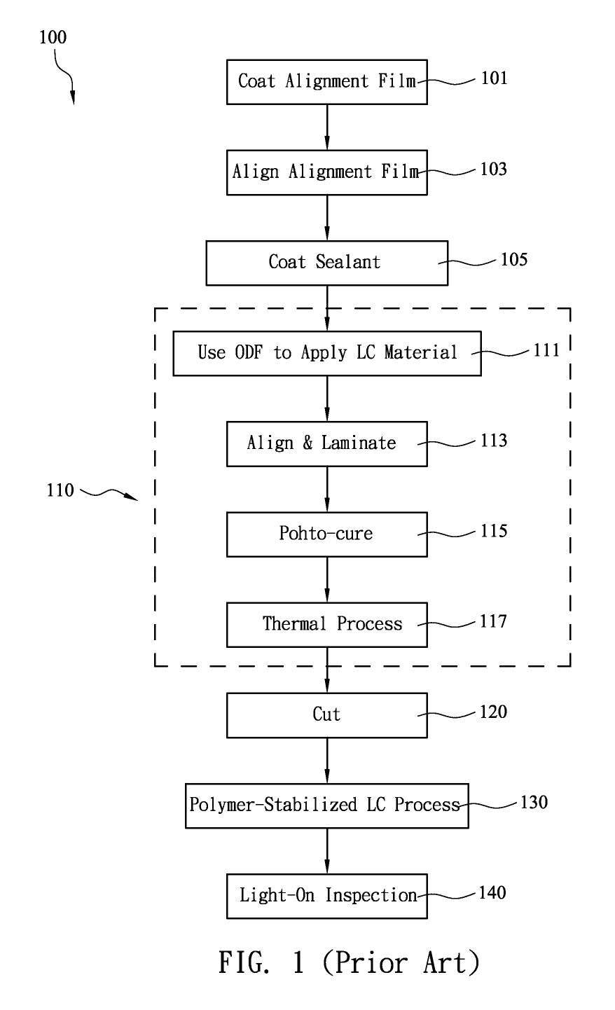

FIG. 2 is a schematic drawing of polymer and liquid crystal molecules;

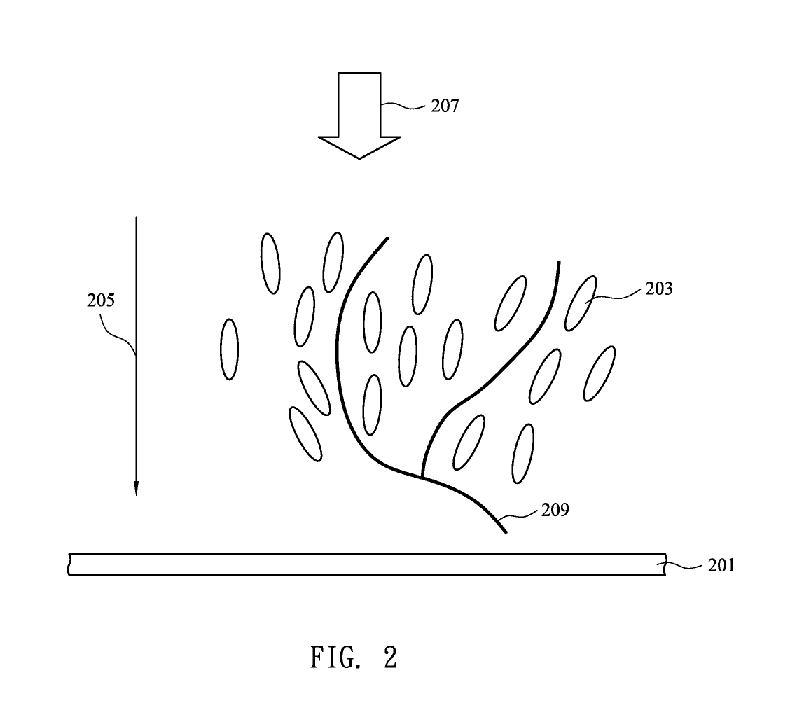

FIG. 3 shows the driving circuit of the conventional liquid crystal display panel;

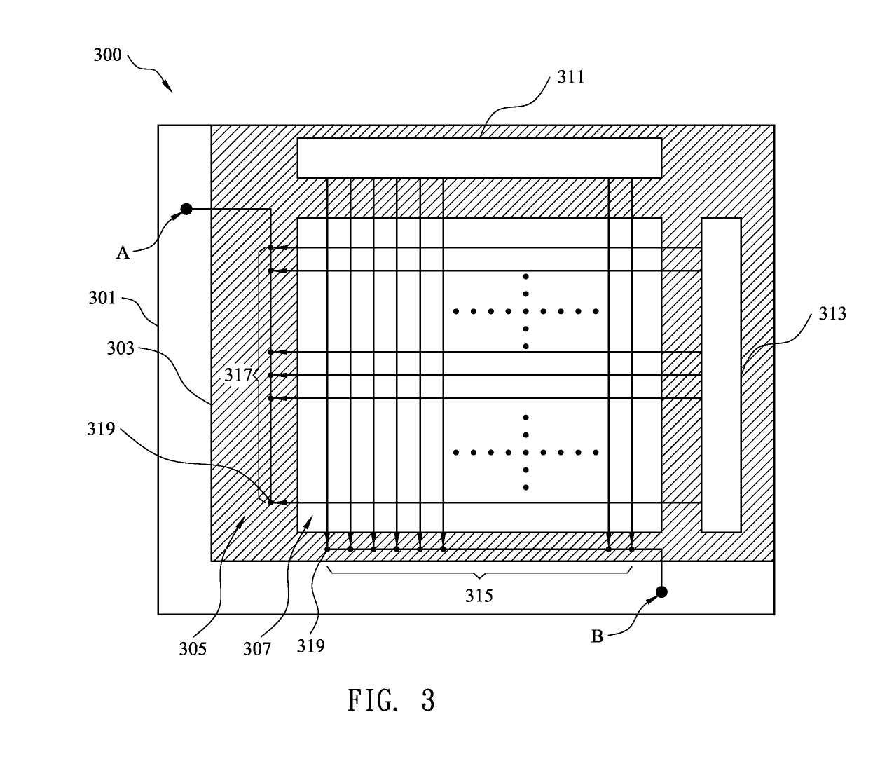

FIG. 4 shows one embodiment for fabricating a liquid crystal display panel;

FIG. 5 shows another embodiment for fabricating a liquid crystal display panel; and

FIG. 6 shows another embodiment for fabricating a liquid crystal display panel.

### DETAILED DESCRIPTION OF THE INVENTION

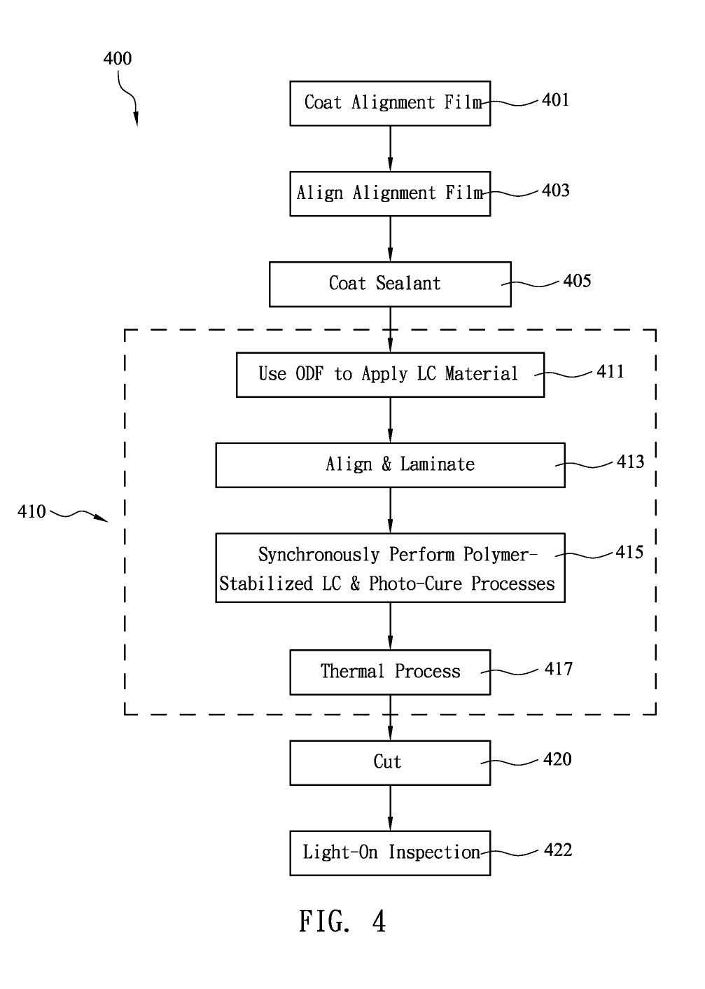

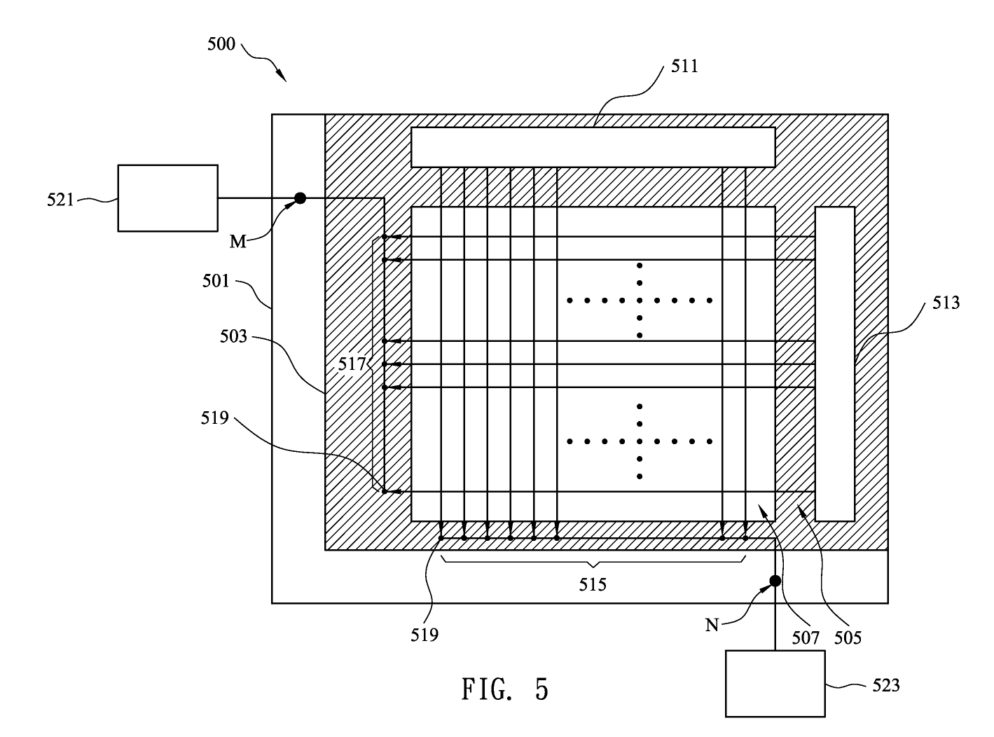

A method of fabricating a liquid crystal display of the present invention is provided by using a one-drop-filling (ODF) method to inject liquid crystal material between two parallel substrates, while a signal input terminal on the substrate is exposed. A voltage and ultra-violet radiation are applied to the signal input terminal synchronously, such that the monomers can be polymerized to stabilize the liquid crystal molecules and to photo-cure a sealant. Thereby, the damage of liquid crystal molecules caused ultra-violet radiation is minimized and the fabrication process is simplified. Detailed description of the process of the present invention can be referred to FIGS. 4 and 5.

In FIG. 4, an embodiment of fabricating a liquid crystal display panel is illustrated. As shown, the fabrication process 400 includes a step 401 for coating an alignment film on each of the substrates comprising the thin-film transistor array and the color filter. In one embodiment, the thin-film transistor array substrate includes transfer unit and two signal input terminals located at the same side. One of the signal input terminals serves as an image signal input terminal, while the other is used for scan signal input terminal. In another embodiment, the signal input terminals can be located at different sides, which will be discussed later in the specification. It will be appreciated that, before coating the alignment film, various alignment structures such as ridges or seams can be formed without exceeding the spirit and scope of the present invention.

In step 403, alignment of the alignment films is performed. The alignment includes rubbing alignment, UV photo alignment, or ion beam alignment. It is worth noting that the fabrication of the liquid crystal display panel, such as the multi-domain vertical alignment (MVA) liquid crystal display panel does not required step 403. That is, after step 401, the sealant is coated between the thin-film transistor array substrate and the color filter array.

Steps 411 and 417 are performed within a one-drop-filling system 410. In step 411, a liquid crystal material is injected on the thin-film transistor array substrate or the color filter substrate by one-drop-filling process. The liquid crystal material includes at least liquid crystal molecules and a small amount of monomers, which can be photo-curing monomers or thermosetting monomers.

In step 413, the substrates are aligned and laminated with the signal input terminals exposed.

In step 415, the polymer stabilization of liquid crystal and photo-curing processes are synchronously performed. More specifically, a voltage is applied to the liquid crystal material via the signal input terminals. The voltage is about 1V to about 20V, preferably 2V to 6V. Thereby, the liquid crystal molecules are stabilized at a predetermined azimuth. Ultra-violet radiation is synchronously applied to the liquid crystal material to polymerize the monomers, so as to cure the sealant. The energy of the ultra-violet radiation is determined according to the characteristics of the monomers. In one embodiment, various types of monomers can be used to form a mixed polymer.

In step 417, a thermal process is performed to further cure the sealant. In step 420, the substrates are cut as desired. In step 422, a light-on inspection is performed. The exposed signal input terminals are used to input inspection signals, which are then transferred to the gate line and the data line via the transfer units. Thereby, the brightness, contrast ratio, and existence of defects such as bad spot or line can be inspected.

To comply with the above process, a driving circuit is provided for the liquid crystal display panel fabricated thereby. As shown in FIG. 5, the liquid crystal display panel 500 includes at least two parallel opposing substrates 503 and 501. A sealant can be formed between the substrates 501 and 503. The substrate 503 includes a light-blocking area 505 and a light-transparent area 507 defined by a color filter. A plurality of parallel data lines 515 and a plurality of parallel gate lines 517 parallel to the data lines 515 are formed on the substrate 501. At least one signal input circuit is also formed on the substrate 501 to couple with the data lines 515 or the gate lines 517. The signal input line extends to the edge of the substrate 501. When the substrates 501 and 503 are laminated with each other, the terminals M, N of the signal input circuit and at least a portion of the signal input circuit are exposed. The signal input terminals M, N can be used as testing electrodes and lead to at least one circuit, by which the liquid crystal display panel can be coupled to external signal suppliers 521 and 523. The intersection between the signal input circuit and each gate line or data line includes a transfer unit 519 such as a thin-film transistor.

In this embodiment, to synchronously perform the polymer-stabilization of liquid crystal and photo-curing process, a voltage is supplied form the external signal supplier 523 to the signal input terminal M and a voltage is supplied from the external signal suppliers 521 and 523 to the data lines 515 and gate lines 51 via the signal input terminals M and N, while ultra-violet radiation is incident on the liquid crystal material. Thereby, the liquid crystal molecules are twisted to the predetermined azimuth, while the sealant is photo-cured at the same time.

After the synchronous polymer-stabilization and photo-curing processes, the laminated substrates are cut as desired. A light-on inspection step is then performed to inspect the brightness, contrast ratio and the defect existence of the liquid crystal display panel.

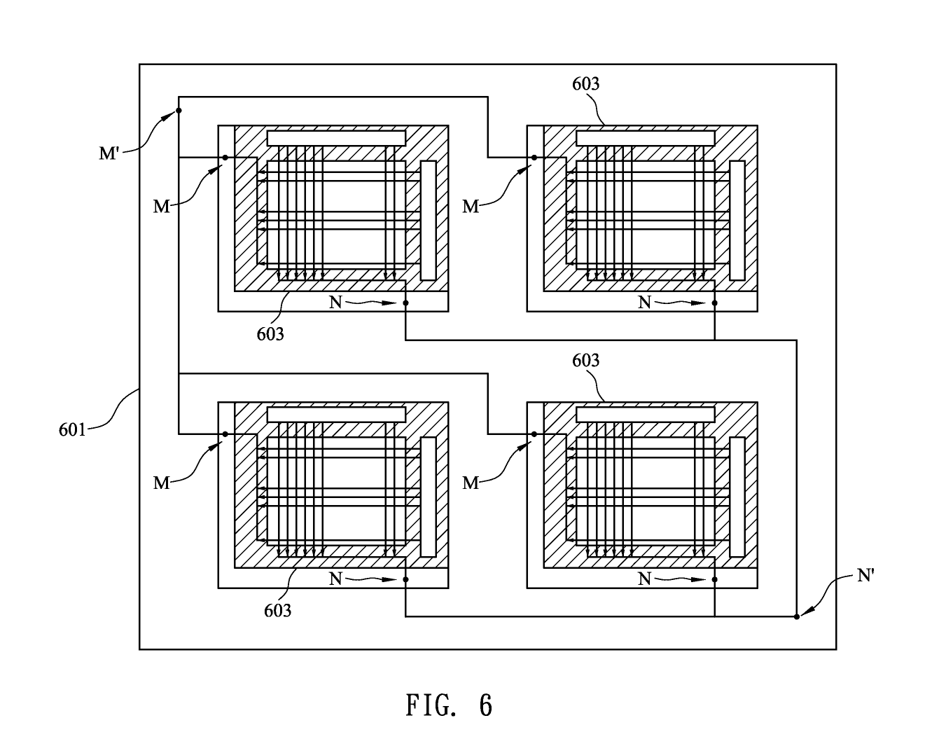

When the driving circuit is applied to fabrication of two or more than two liquid crystal display panels, the signal input terminals M and N can further extend to lead at least one circuit for coupling to external signal suppliers 521 and 523. FIG. 6 shows a driving circuit of a liquid crystal display panel. As shown, the substrates 601 and 603 are defined into four liquid crystal display panel areas. The signal input terminals M and N extend further to lead a circuit, by which the signal input terminals M′ and N′ are coupled for inputting voltage or signal. The amount of the liquid crystal display panels defined on the substrates 601 and 603 are not limited to four.

The signal input terminals are reserved and exposed allowing subsequent inspection step such as light-on inspection to be performed after the synchronous polymer-stabilization of liquid crystal and photo-curing process. By the exposed signal input terminals, external source can input voltage or signal into the liquid crystal display for inspection or signal scan.

By the above method, the synchronously performed polymer-stabilization and photo-cure reduces the radiation times of ultraviolet, such that the damage caused thereby is minimized, the process is simplified, and the cost is reduced, while the quality of the liquid crystal display panel is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of fabricating a liquid crystal display panel, comprising:
providing two substrates and a sealant formed on at least one of the substrates;
applying a liquid crystal material on at last one of the substrate, wherein the liquid crystal material includes at least a plurality of liquid crystal molecules and a monomer;
laminating the substrates in parallel and keeping at least one signal input terminal exposed; and
applying a voltage to the signal input terminal and radiating the liquid crystal material by an ultraviolet beam synchronously to polymerize the monomer, so as to photo-cure the sealant.

2. The method of claim 1, wherein the voltage is about 1V to about 20V.

3. The method of claim 2, wherein the voltage is about 2V to 6V.

4. The method of claim 1, further comprising a step of thermal process to thermally cure the sealant.

5. The method of claim 4, further comprising the following steps after the step of thermal process:
cutting the laminated substrates; and
performing a light-on inspection by supplying a signal via the exposed signal input terminal.

6. The method of claim 1, wherein the fabrication of the liquid crystal display panel is performed within a one-drop-filling system.

7. A method of fabricating a liquid crystal display panel, comprising:
providing a liquid crystal material between two substrates, and a sealant formed on at least one of the substrates, wherein the substrates are parallel to each other and laminated with at least one signal input terminal exposed; and
applying a voltage to the signal input terminal and radiating the liquid crystal by an ultraviolet beam simultaneously to polymerize monomers contained in the liquid crystal material and to photo-cure the sealant.

8. The method of claim 7, wherein the liquid crystal material is inserted between the substrates by a one-drop-filling method.

9. The method of claim 7, wherein the voltage is about 1V to about 20V.

10. The method of claim 9, wherein the voltage is about 2V to 6V.

11. The method of claim 9, further comprising a step of thermal process to thermally cure the sealant.

12. The method of claim 11, further comprising the following steps after the step of thermal process:
cutting the laminated substrates; and
performing a light-on inspection by supplying a signal via the exposed signal input terminal.

13. The method of claim 7, wherein the fabrication of the liquid crystal display panel is performed within a one-drop-filling system.
